(19) United States
(12) Patent Application Publication
(10) Pub. No.: US 2007/0299690 A1
(43) Pub. Date: Dec. 27, 2007

(54) Health care method

(75) Inventors: Cliff Frank, Atlantic Beach, FL (US); James A. Duncan, (US)

Correspondence Address: CROWELL & MORING LLP;INTELLECTUAL PROPERTY GROUP, P.O. BOX 14300, WASHINGTON, DC, 20044-4300, US

(73) Assignee: Vermont Manage Care, Inc., Burlington, VT (US)

(21) Appl. No.: 11/783,391

(22) Filed: Apr. 9, 2007

Related U.S. Application Data
(60) Provisional application No. 60/789,971, filed on Apr. 7, 2006.

(51) Int. Cl. G06Q 50/00; G06Q 10/00

(52) U.S. Cl. 705/2

(57) ABSTRACT

The present invention is directed to methods of administering health care insurance benefits. In particular, the present invention is directed to methods of providing health care coverage in which clinical services are differentiated into different clinical categories, which correspond with different levels of insurance benefits. The clinical categories include Preventive or Chronic Care Services, Core Services, Standard Services, and non-covered services.

### FIELD OF THE INVENTION

The present invention is directed to methods of administering health care insurance coverage and benefits. In particular, the present invention is directed to methods of providing health care coverage and benefits in which clinical services are differentiated into different clinical categories, which correspond with different levels of insurance coverage and benefits.

### BACKGROUND OF THE INVENTION

Health insurance is a type of insurance whereby the insurer pays some or all of the medical costs of the insured if the insured becomes sick or incapacitated due to a covered disease, cause, or accident. The insurer may be a private organization or a government agency. Market-based health care systems such as that in the United States rely primarily on private health insurance. Currently, approximately 85% of Americans have health insurance. Because of advances in medicine, drugs, and medical technology, medical treatment is more expensive and people in developed countries are living longer. The population of the country is aging, and a growing group of senior citizens requires more medical care than a young healthier population. These factors cause an increase in the cost of health insurance. The cost of health insurance is also adversely impacted by fundamental inefficiencies that are present in most health insurance programs resulting in higher health insurance costs.

Traditional health insurance programs and managed care offerings provide coverage and benefits for health care services on an either/or basis. Either the service is covered, or it is excluded if the service is cosmetic, experimental, or not medically necessary. Health insurance covers the removal of a wart or an arterial blockage at the same level of coverage and benefits. Thus, there is a need for a health insurance program that provides coverage where it is needed most—on preventive care and chronic care for the most serious illnesses and conditions—and provides less coverage where the services are elective or less critical to the well being of the insured. The present invention provides just such a health insurance program.

### SUMMARY OF THE INVENTION

One embodiment of the present invention encompasses methods of administering health care insurance coverage and benefits for medical and surgical health care services.

Another embodiment of the instant invention encompasses methods of providing health care coverage and benefits in which clinical services are differentiated into specific clinical categories, which correspond with different levels of insurance coverage and benefits.

Yet another embodiment of the instant invention is directed to a method of determining the percentage of the cost of health care that a health care benefit plan will pay through the creation and use of a database wherein a plurality of standard diagnoses are organized into distinct clinical categories, assigning a percentage value to each of the diagnosis categories, reviewing the diagnoses of a patient as determined by the patient's physician and comparing the patient's diagnoses to the data base, in order to determine the coverage and benefit category of the diagnoses, and then providing the patient with a percentage or portion of the cost of health care as a covered benefit based on the coverage and benefit category in which the diagnosis is assigned.

A further embodiment of the instant invention encompasses a method of providing health care insurance wherein diagnoses are organized in to the following coverage and benefit categories: Preventive or Chronic Care Services, Core Services (same as high clinical criticality services), Standard Services (same as low clinical criticality services), and non-covered services.

### BRIEF DESCRIPTION OF THE FIGURES

FIG. 1 shows a graph that illustrates an example of health care insurance benefit coverage.

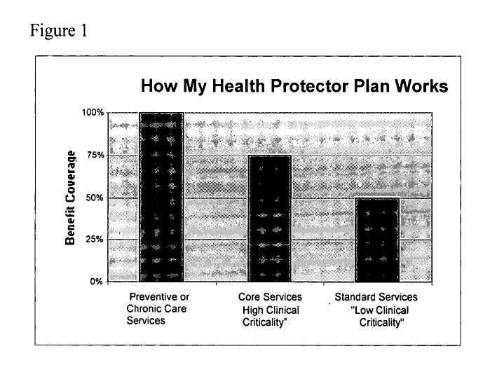

### DETAILED DESCRIPTION OF THE INVENTION

For simplicity and illustrative purposes, the principles of the present invention are described by referring to various exemplary embodiments thereof. Although the preferred embodiments of the present invention are particularly disclosed herein, one of ordinary skill in the art will readily recognize that the same principles are equally applicable to, and can be implemented in other systems, and that any such variations or modifications would be within the scope of the present invention and such variations or modifications do not depart from the scope of the present invention. Before explaining the disclosed embodiments of the present invention in detail, it is to be understood that the present invention is not limited in its application to the details of any particular arrangement shown, since the present invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement or order of steps as described or disclosed herein.

The present invention is directed to methods of providing health care insurance benefits in which clinical services are differentiated into distinct clinical categories which correspond with different levels of insurance benefits. The International Statistical Classification of Diseases and Related Health Problems (“ICD”) provides codes to classify diseases and a wide variety of signs, symptoms, abnormal findings, complaints, social circumstances and external causes of injury or disease. Current Procedural Terminology (“CPT”) is a listing of descriptive terms and identifying codes for reporting medical services and procedures performed by a health care provider.

Every health condition can be assigned to a unique clinical category and given a descriptive code, utilizing ICD and CPT. Such categories typically include a set of similar diseases. In developing the present invention, and in consultation with medical specialists, we have classified over 14,000 standard diagnosis (ICD) codes into one of three clinical categories: Preventive or Chronic Care Services, Core Services, or Standard Services (low clinical criticality). ICD and CPT codes are updated at least annually and the diagnoses assigned to the clinical categories will be reviewed and updated accordingly.

These codes and their classifications are included on the CD and copy thereof filed concurrently with the present application, hereby incorporated by reference. The CD contains the following files: Adult Preventive Apr. 6, 2007 26 KB; Asthma Dx Codes Apr. 6, 2007 14 KB; Asthma Preventive Codes Apr. 6, 2007 20 KB; Behavioral Health Preventive . . . Apr. 6, 2007 14 KB; CHF Dx Codes Apr. 6, 2007 15 KB; CHF Preventive Codes Apr. 6, 2007 21 KB; COPD Dx Codes Apr. 6, 2007 15 KB; COPD Preventive Codes Apr. 6, 2007 45 KB; Denied List Apr. 6, 2007 Apr. 6, 2007 215 KB; Diabetes Preventive Codes Apr. 6, 2007 19 KB; Diabetic Dx Codes Apr. 6, 2007 15 KB; High Criticality List Apr. 6, 2007 3,055 KB; Low Criticality List Apr. 6, 2007 144 KB; Maternity Preventive Apr. 6, 2007 23 KB; and Pediatric Preventive Codes Apr. 6, 2007 67 KB.

The insured benefit that a patient receives is based on the associated clinical category for the health care service diagnosis. For example, Preventive or Chronic Care Services may be covered up to 100% less applicable co-payments. Standard Services—those services that are elective in nature or less critical to the well being of the insured—are covered at 50% less applicable co-payments or co-insurance. When a doctor provides services to a patient, the benefit level to which the patient is entitled under the insured benefit of the present invention is determined by the clinical category that the diagnosis code falls into. If a patient has multiple problems and their doctor records multiple diagnoses, some in the Core Services category, and some in the Standard Services category, services will be matched to the diagnosis and its coverage and benefit category and paid at the appropriate benefit level. A fundamental element of the present invention is the differentiation of clinical services into distinct clinical categories, which correspond with different levels of insurance benefits. Exemplary clinical categories may include:
(1) Preventive or Chronic Care Services and selected chronic conditions—paid at 100%
(2) Core Services—paid at 75%
(3) Standard Services (low clinical criticality)—paid at 50%
(4) Non-covered services—paid at 0%

The present invention recognizes the value of preventive health care. The medical literature contains many studies that show that when patients receive preventive health care services that find problems early, the patient and the insurer avoid a lot of downstream medical costs. The present invention takes the value of preventive health care into account and treats it accordingly by paying preventive health care at the highest levels. The same use of providing preventive care to patients with chronic illnesses also has shown to reduce downstream medical costs.

Unlike many programs, the principals encompassed by the present invention may be implemented by insurers so the patient may not be required to obtain a referral from a primary care physician for a patient to receive full benefit for a specialist visit. Specialist visits may have a substantially higher co-payment, but if a patient wants to see a specialist without the hassle of obtaining a referral, the patient may be able do so, and insurer coverage and benefit designs using the principals of the present invention will pay for the services based on the clinical category of the diagnoses—either Core Services or Standard Services as applicable.

At times, a diagnosis may be categorized as a Standard Service when it is the only diagnosis for the health care service being provided. That same diagnosis, in conjunction with another underlying and complicating diagnosis, may be covered as a Preventive or Chronic Care Service. For example, a foot ulcer may be considered a Standard Service and only covered at 50%, less applicable co-payments or co-insurance. But, for the patient with a diabetes diagnosis, the foot care is much more medically important, and would be covered as a Preventive or Chronic Care Service, at 100%, less applicable co-payments or co-insurance. Insurance plans utilizing the principals of the present invention will provide higher paying benefits for patients with complicating diagnoses where this type of situation applies including, but not limited to: diabetes, chronic obstructive pulmonary disease, congestive heart failure, asthma, and several others.

The present invention may or may not rely on front-end deductibles to shift costs to patients. A patient is notified in advance of what services are covered benefits, under what diagnosis or diagnoses, and what the co-payments or co-insurance are that go along with the coverage and benefits that insure the patient. Therefore, when going to a participating network doctor or hospital, the patient will know in advance what their financial obligation will be, and what their insurer will pay, at the time they receive the medical services.

### EXAMPLE 1

Diagnosis Code Review for Standard Services (Low Clinical Criticality)

In order to assign diagnoses to the appropriate category, both the ICD-9 and CPT-4 codes were reviewed. The goal of the ICD-9 code review was to identify a subset of codes which represent diagnoses of relatively low clinical criticality. Of the approximately 14,000 total codes, over 1,300 such codes were applied to the Standard Services (low clinical criticality) category. Each such diagnosis is one which, under most circumstances, is very unlikely to be of significant medical severity, i.e. to require medical intervention to prevent immediate or long-term serious adverse health consequences. It is understood that there may be some benefit to the patient from treating such a diagnosis. It is also understood that there may be specific circumstances in which such a diagnosis could represent a significant condition which may justify considering it to be a higher severity condition.

The results of the diagnosis code review are shown in Table 1.

TABLE 1
ICD-9 Low-Criticality Diagnosis Examples

| | |
|---|---|
| simple childhood viruses | dental cavities |
| simple warts | gingivitis |
| sore throat | jutting or receding jaw |
| laryngitis | TMJ disorders |
| colds | GERD (reflux) |
| bronchitis | hernias without |
| | complication |
| allergic rhinitis (hay fever) | constipation |
| yeast infections | irritable bowel syndrome |
| vaginitis | ovarian cyst |
| lice | anal spasm |
| lipomas | functional bladder disorders |
| benign skin lesions | BPH (enlarged prostate) |
| premature menopause | hydrocele |
| low testicular function | cystocele |
| dementia | impotence |
| insomnia | low sperm count |
| hypersomnia (excessive sleepiness) | breast hypertrophy or |
| | atrophy |
| writers cramp | malpositioned uterus |
| cataracts | tight hymen |
| near-sightedness | painful intercourse |
| far-sightedness | menstrual cramps |
| color blindness | irregular menstruation |
| allergic conjunctivitis | menopause |
| ptosis and blepharochalasis (droopy eyelids) | infertility |
| excessive eyelid hair | retracted nipples |
| dry eyes | seborrhea |
| excessive tears | diaper rash |
| ear wax | sunburn |
| tinnitus (ringing in the ears) | allergic dermatitis |
| hearing loss | rosacea |
| varicose veins | corns, calluses |
| hemorrhoids | ingrown nail |
| baldness | osteoarthritis |
| excessive hair | stiff joints |
| excessive sweating | neck pain |
| bunions | low back pain |
| ganglions | loose ligaments |
| hammer toe | muscle cramps |
| baker's cyst | tendonitis |
| knock-knee | osteoporosis |
| big ears | scoliosis |
| pigeon breast | curvature of spine |
| sunken chest | short stature |
| flatulence | loss of height |
| diarrhea | dyslexia |
| hiccoughs | excessive crying baby |
| chronic fatigue | incontinence |
| nervousness | enuresis |
| decreased libido | sprains |
| blisters | abrasions |
| contusions | first-degree burns |

### EXAMPLE 2

Preventive or Chronic Care Services Examples

Paid at 100%, less insured $10 office co-payment

1Annual gynecological exam for women
Mammography
Well-child care
PSA screening tests for prostate cancer
Periodic physicals
Vaccinations and Immunizations

### EXAMPLE 3

Core Services Examples

Paid at 75% after the annual deductible is met; insured pays 25% co-insurance
Heart Surgery
Cancer care including surgery, chemotherapy, and radiation therapy
Hospital in-patient care for Core Services diagnoses
Labor and Delivery
ALS, Muscular Dystrophy, Multiple Sclerosis
Kidney failure, Liver failure
Bi-Polar disorder

### EXAMPLE 4

Standard Services (Low Clinical Criticality) Examples

Paid at 50% after the annual deductible is met; insured pays 50% co-insurance
Acne treatment
Ingrown toenails
Hemorrhoid treatment
Ankle sprain—mild
Hospital in-patient care

### EXAMPLE 5

The following embodiment of the present invention provides coverage and benefits where they are needed most and provides less coverage and benefits when the services are elective or less critical to the well being of the patient. This embodiment provides 3 categories of coverage and benefit, based on diagnosis code (both ICD and CPT). The coverage and benefit categories are illustrated below where Preventive or Chronic Care Services are paid at 100%, Core Services are paid at 75%, and Standard Services are paid at 50%.

I. Benefit Level Based on Diagnoses and Coverage Level

A. Preventive or Chronic Care Services (Insurer Pays 100%, After $10 Office Visit Co-Pay) which is Defined as Routine Outpatient Care for Preventive or Chronic Care Services

Pediatric Preventive Services
(unless otherwise noted, all services annually)

| | |
|---|---|
| Age 0-12 months | |
| Office Evaluation | 6 visits |
| Hematocrit | 1 test |
| Lead Screening | 1 test |
| Immunizations** | All |
| TB Test | 1 test |
| Age 12-24 months | |
| Office Evaluation | 3 visits |
| Hematocrit | 1 test |
| Lead Screening | 2 tests |
| Immunizations** | All |
| TB Test | 1 test |
| Age 24-36 months | |
| Office Evaluation | 2 visits |
| Immunizations** | All |
| Hematocrit* | 1 annually |
| Lead screening* | 1 annually |
| TB Test* | 1 annually |
| Age 3-5 years | |
| Office Evaluation | 1 visit |
| Immunizations** | All |
| Hematocrit* | 1 annually |
| Lead screening* | 1 annually |
| TB Test* | 1 annually |
| Vision | 1 annually |
| Audiometry | 1 annually |
| Urinalysis | 1 annually |
| Age 6-10 years | |
| Office Evaluation | 1 visit |
| Immunizations** | All |
| Hematocrit | 1 annually |
| TB Test* | 1 annually |
| Vision | 1 annually |
| Audiometry | 1 annually |
| Age 11-18 years | |
| Office Evaluation | 1 visit |
| Immunizations** | All |
| Hematocrit* | 1 annually |
| TB test* | 1 annually |
| Vision | 1 annually |
| Audiometry* | 1 annually |
| Urinalysis* | 1 annually |
| Pap Testing* | 1 annually |
| Chlamydia Testing* | All |
| Gonorrhea Testing* | All |

*These services shall be provided on the basis of an individual risk
assessment
**DTaP, DT, Td, Tdap, MMR, IPV, Hib, HepA, HepB, HPV, MCV4
(meningococcal), PCV, Varicella, Influenza, Rotavirus

Adult Preventive Services (all mo more than once annually)

Office Evaluation
Lipid Profile
Pap Test
Mammography
Fecal Occult Blood
Screening Colonoscopy (in accord with ACG guidelines)
PSA
Chlamydia/gonorrhea test (sexually active women 25 and younger)
Vaccinations* (all covered if given in accordance to ACIP
guidelines except NOT for employment or travel)

*HepA, HepB, HPV, Influenza, Meningococcal, Pneumococcal, Td, Tdap,
Varicella, Zostavax

Maternity Preventive Services

| | |
|---|---|
| Office Evaluation | 15 visits |
| Ultrasound | 1 study |
| Pap test | All |
| CBC | All |
| Group B Strep culture | All |
| Glucose | All |
| Glucose tolerance test | All |
| Urinalysis | All |
| Urine culture | All |
| Rubella titre | All |
| Alpha-fetoprotein | All |
| HBsAg | All |
| HepC Ab | All |
| HIV | All |
| Syphilis | All |
| Gonorrhea | All |
| Chlamydia | All |
| Blood type Rh and antibody screen | All |
| Influenza vaccine | All |

Asthma Preventive or Chronic Care Services

| | |
|---|---|
| Office Evaluation | Up to 4 times annually (ICSI) |
| Pulmonology Consult | Annual |
| Allergy Consult | Annual |
| Pulmonary Function Testing | Annual (ICSI) |
| Influenza Vaccine | Annual (ICSI) |
| Chest X-Ray | Annual |

CHF (ACC/AHA) Preventive or Chronic Care Services

| | |
|---|---|
| Office Evaluation | Up to 2 times annual |
| Influenza Vaccine | Annual |
| Pneumococcal Vaccine | Every 5 years |
| EKG | 2 times per year |
| Chest X-Ray | 2 times per year |
| Oxygen Therapy | All |

CORD Preventive or Chronic Care Services

| | |
|---|---|
| Office Evaluation | Up to 4 times annually (ICSI) |
| Pulmonology Consult | Annual |
| Pulmonary Function Testing | Annual |
| Influenza Vaccine | Annual |
| Pneumococcal Vaccine | Every 5 years |
| Chest X-Ray | 2 times per year |
| Oxygen Therapy | All |

Diabetes Preventive or Chronic Care Services

| | |
|---|---|
| Office Evaluation | Twice annual |
| | (Michigan Consortium [MQIC]) |
| Lipid Measurement | Annual |
| HbA1C | Up to 4 times per year |
| Foot Exam | Annual (VPQHC); twice annual |
| | (MQIC) |
| Urine Microalbumin | Annual |
| Dilated Eye Exam | Annual |
| Nutritional Counseling | Annual |
| Endocrinologist | Annual |
| Diabetic Educator | Annual |

Behavioral Health

| | |
|---|---|
| Office Evaluation for | Annually |
| Pharmacologic Management | |
| (CPT code 90862) | |

B. Core Services (High Clinical Criticality)
Insurer pays 75%, insured pays 25% co-insurance
$500 annual deductible per insured
$5,000 annual insured out-of-pocket maximum (which includes the deductible)
The deductible and out-of-pocket maximum are shared with the Standard Services category
After the insured has fulfilled the annual out-of-pocket maximum, the insurer pays 100% of covered services

Examples
Heart Surgery
Cancer Care including surgery, chemotherapy, and radiation therapy
Hospital in-patient care for Core Services diagnoses
ALS, Muscular Dystrophy, Multiple Sclerosis
Kidney failure, Liver failure
Bi-Polar disorder

C. Standard Services (Low Clinical Criticality)
Insurer pays 50%, insured pays 50% co-insurance
$500 annual deductible per insured
$5,000 annual insured out-of-pocket maximum (which includes the deductible)
The deductible and the out-of-pocket maximum are shared with the Core Services category
After the insured has fulfilled the annual out-of-pocket maximum, the insurer pays 100% of covered services
Examples:
Inpatient benefits
Acne treatment
Ingrown toenails
Hemorrhoid treatment
Ankle sprain—mild
   II. Exclusions/Non-Covered Services

Insurer pays 0%, insured pays 100%

III. Limitations

Coverage and benefits vary by insurance product

IV. Co-Payments

Co-payments apply only to Preventive or Chronic Care Services

V. Co-Insurance

Insured is responsible for co-insurance depending on service rendered

Co-insurance applies to Core Services and Standard Services

VI. No Out-of-Network Deductible

VII. Annual Coverage and Benefit Deductible

Individual deductible: $500

Family deductible: $1,000

Annual coverage and benefit deductible applies to Core Services and Standard Services

VIII. Annual Out of Pocket Maximum for Medical

Individual deductible: $5,000

Family deductible: $10,000

IX. Lifetime Maximum

$2 million lifetime maximum benefit per insured

X. Out-of-Network Coverage

PPO Product model for permanent out-of-network insured

“Temporary” out-of-network insured (such as a student) would continue on the basic coverage and benefit design, accessing providers via a PPO wrap network at the negotiated maximum allowable rate

Variable, based on insured coverage and benefit design

XI. Prescription Drug Benefit (Note: Final Design Still in Progress)

Drugs are classified into “Therapeutic Classes” where drugs with a high clinical value are paid at a higher benefit level by the insurer

Separate prescription drug deductible:
$100 per insured maximum
$200 per family maximum

Separate prescription drug out-of-pocket maximum; Co-payments, co-insurance and deductibles accumulate toward the prescription drug out-of-pocket maximum:
$2000 per insured
$4000 per family

Co-insurance/deductible amount depends on the Pharmacy Tier for the pharmaceutical dispensed
Pharmacy Tier 1: 10% Co-insurance/no deductible
Pharmacy Tier 2: 25% Co-insurance/deductible applies
Pharmacy Tier 3: 50% Co-insurance/deductible applies

The co-insurance on Pharmacy Tier 1 brand drugs shall be capped at $30 per script fill

There is no cap per script fill on Pharmacy Tier 2&3 brand drugs

Pharmacy Tier 1 generics will have a flat $5 co-payment

Pharmacy Tier 2&3 generics will have a flat $10 co-payment

All multi-source drugs (brand drugs that have a generic formulation (i.e., Prozac, Zocor) require mandatory generic substitution

Use of mail order may be at the option of the insured

Mail order benefit is two times co-payment/co-insurance for a 90-day fill

Pharmacy TIER 1 -
10% co-insurance on brand drugs in the following therapeutic classes:

| | |
|---|---|
| COPD | All inclusive |
| Asthma | All inclusive |
| Diabetes | All inclusive |
| Cardiovascular | All inclusive |
| Psychotropic & antidepressants | All inclusive |

Pharmacy TIER 2 -
25% co-insurance on all brand drugs NOT in TIER 1&3,
including the following:

| | |
|---|---|
| Antianxiety | BPH - Flomax, etc. |
| Glaucoma | Alzheimers/dementia |
| Osteoporosis | |
| Antibiotics | |
| Multiple Sclerosis | |
| Rheumatoid Arthritis | |

Pharmacy TIER 3 - 50% co-insurance on brand drugs
in the following identified therapeutic classes:

Cough & cold medications
Hypnotics (sleep)
Hypersomnia (Provigil) prior auth required
Opthalmic products except glaucoma
OTIC (ear) products
Erectile dysfunction
PPI's, H2's-treating reflux, heartburn-Prilosec OTC covered at zero
co-payment and step therapy required
Non-steroidal analgesics for treatment of osteoarthritis (Prior
authorization-step therapy for Celebrex)
Incontinence
Rx laxatives
Dermatology products-those products identified as cosmetic
excluded benefit prior authorization required

XI. Behavioral Health

Preventive or Chronic Care Service, or Core Service, depending on service

Preventive or Chronic Care Service for annual office evaluation for pharmacologic management

Exclusions and limitations apply

While the present invention has been described with reference to certain exemplary embodiments thereof, those skilled in the art may make various modifications to the described embodiments of the present invention without departing from the scope of the present invention. The terms and descriptions used herein are set forth by way of illustration only and are not meant as limitations. In particular, although the present invention has been described by way of examples, a variety of methods may be implemented in order to practice the inventive concepts described herein. Although the present invention has been described and disclosed in various terms and certain embodiments, the scope of the present invention is not intended to be, nor should it be deemed to be, limited thereby and such other modifications or embodiments as may be suggested by the teachings herein are particularly reserved, especially as they fall within the breadth and scope of the present invention claims here appended. Those skilled in the art will recognize that these and other variations are possible within the scope of the present invention as defined in the following claims and their equivalents.

| Name of File | Size-bytes | Created | File Type | Readable With |
|---|---|---|---|---|
| Adult Preventive | 9,721 | Aug. 2, 2007 | ASCII | Microsoft |
| | | | text only | Windows |
| | | | | Notepad or |
| | | | | any |
| | | | | Wordprocessor |
| Asthma Dx Codes | 468 | Aug. 2, 2007 | ASCII | Microsoft |
| | | | text only | Windows |
| | | | | Notepad or |
| | | | | any |
| | | | | Wordprocessor |
| Asthma | 6,164 | Aug. 2, 2007 | ASCII | Microsoft |
| Preventive Codes | | | text only | Windows |
| | | | | Notepad or |
| | | | | any |
| | | | | Wordprocessor |
| Behavioral Heath | 190 | Aug. 2, 2007 | ASCII | Microsoft |
| Preventative Code | | | text only | Windows |
| Sheet 1 | | | | Notepad or |
| | | | | any |
| | | | | Wordprocessor |
| CHF Dx Codes | 863 | Aug. 2, 2007 | ASCII | Microsoft |
| | | | text only | Windows |
| | | | | Notepad or |
| | | | | any |
| | | | | Wordprocessor |
| CHF Preventive | 8,281 | Aug. 2, 2007 | ASCII | Microsoft |
| Codes | | | text only | Windows |
| | | | | Notepad or |
| | | | | any |
| | | | | Wordprocessor |
| COPD Dx Codes | 636 | Aug. 2, 2007 | ASCII | Microsoft |
| | | | text only | Windows |
| | | | | Notepad or |
| | | | | any |
| | | | | Wordprocessor |
| COPD Preventive | 138,463 | Aug. 2, 2007 | ASCII | Microsoft |
| Codes | | | text only | Windows |
| | | | | Notepad or |
| | | | | any |
| | | | | Wordprocessor |
| Denied List | 87,859 | Aug. 2, 2007 | ASCII | Microsoft |
| 4-6-07 | | | text only | Windows |
| | | | | Notepad or |
| | | | | any |
| | | | | Wordprocessor |
| Diabetes | 5,783 | Aug. 2, 2007 | ASCII | Microsoft |
| Preventive Codes | | | text only | Windows |
| | | | | Notepad or |
| | | | | any |
| | | | | Wordprocessor |
| Diabetic Dx | 1,828 | Aug. 2, 2007 | ASCII | Microsoft |
| Codes | | | text only | Windows |
| | | | | Notepad or |
| | | | | any |
| | | | | Wordprocessor |
| High Criticality | 1,325,297 | Aug. 2, 2007 | ASCII | Microsoft |
| List 4-6-07 | | | text only | Windows |
| | | | | Notepad or |
| | | | | any |
| | | | | Wordprocessor |
| Low Criticality | 47,312 | Aug. 2, 2007 | ASCII | Microsoft |
| List 4-6-07 | | | text only | Windows |
| | | | | Notepad or |
| | | | | any |
| | | | | Wordprocessor |
| Maternity | 7,187 | Aug. 2, 2007 | ASCII | Microsoft |
| Preventive | | | text only | Windows |
| | | | | Notepad or |
| | | | | any |
| | | | | Wordprocessor |
| Pediatric | 5,794 | Aug. 2, 2007 | ASCII | Microsoft |
| Preventive | | | text only | Windows |
| Codes | | | | Notepad or |
| | | | | any |
| | | | | Wordprocessor |
| Pediatric | 7,174 | Aug. 2, 2007 | ASCII | Microsoft |
| Preventive Codes | | | text only | Windows |
| Age 3-5 yrs | | | | Notepad or |
| | | | | any |
| | | | | Wordprocessor |
| Pediatric | 6,786 | Aug. 2, 2007 | ASCII | Microsoft |
| Preventive Codes | | | text only | Windows |
| Age 6-10 yrs | | | | Notepad or |
| | | | | any |
| | | | | Wordprocessor |
| Pediatric | 10,657 | Aug. 2, 2007 | ASCII | Microsoft |
| Preventive Codes | | | text only | Windows |
| Age 11-18 yrs | | | | Notepad or |
| | | | | any |
| | | | | Wordprocessor |
| Pediatric | 5,767 | Aug. 2, 2007 | ASCII | Microsoft |
| Preventive Codes | | | text only | Windows |
| Age 12-24 Mos. | | | | Notepad or |
| | | | | any |
| | | | | Wordprocessor |
| Pediatric | 5,617 | Aug. 2, 2007 | ASCII | Microsoft |
| Preventive Codes | | | text only | Windows |
| Age 24-36 Mos. | | | | Notepad or |
| | | | | any |
| | | | | Wordprocessor |

What is claimed for the present invention is:

1. A method determining the percentage of the cost of health care that a health care benefit plan will pay comprising:
providing a database wherein a plurality of standard diagnosis and/or medical procedures are organized into clinical categories;
assigning a percentage value to each of the categories;
determining a patient diagnosis;
comparing the patient's diagnosis to the data base in order to determine the category of the diagnosis;
providing the patient with a percentage or portion of the cost of health care based on the category in which the diagnosis and/or procedure is assigned.

2. The method of claim 1, wherein the diagnosis and/or procedures are organized in to the following classes: Preventive or Chronic Care Services, Core Services, Standard Services (low clinical criticality), and non-covered services.

3. The method of claim 2, wherein the health care associated with diagnoses classified as Preventive or Chronic Care Services are paid at 100% of the cost of the health care, after insured co-payments.

4. The method of claim 2, wherein the health care associated with diagnosis classified as Core Services are paid at 75% of the cost of the health care, after the insured annual deductible is met; insured pays 25% co-insurance.

5. The method of claim 2, wherein the health care associated with a diagnosis classified as Standard Services (low clinical criticality) are covered at 50% of the cost of the health care, after the insured annual deductible is met; insured pays 50% co-insurance.

6. A method of providing health care insurance coverage and benefits comprising:
providing a database wherein a plurality of standard diagnosis and medical procedures are organized into clinical categories;
assigning a value to each of the diagnosis categories;
determining a patient diagnosis;
comparing the patient's diagnosis to the data base in order to determine the category of the diagnosis;
providing a pre-determined amount of health care benefits based on the category in which the diagnosis is assigned.

7. The method of claim 6, wherein the diagnosis are organized in to the following classes: Preventive or Chronic Care Services, Core Services, Standard Services (low clinical criticality), and non-covered services.

8. The method of claim 7, wherein the health care associated with diagnoses classified as Preventive or Chronic Care Services is paid at 100% of the cost of the health care, after insured co-payments.

9. The method of claim 7, wherein the health care associated with a diagnosis classified as Core Services are paid at 75% of the cost of the health care, after the insured annual deductible is met; insured pays 25% co-insurance.

10. The method of claim 7, wherein the health care associated with the diagnosis classified as Standard Services (low clinical criticality) are covered at 50% of the cost of the health care, after the insured annual deductible is met; insured pays 50% co-insurance.
